(19) United States
(12) Patent Application Publication
(10) Pub. No.: US 2023/0218937 A1
(43) Pub. Date: Jul. 13, 2023

(54) WILDFIRE CONTAINMENT METHODS

(71) Applicant: Mark David Groben, London (GB)

(72) Inventor: Mark David Groben, London (GB)

(21) Appl. No.: 18/124,293

(22) Filed: Mar. 21, 2023

Related U.S. Application Data
(63) Continuation-in-part of application No. 16/627,084, filed on Dec. 27, 2019, now abandoned.

(30) Foreign Application Priority Data
Jun. 27, 2017 (GB) 1710254.2

(51) Int. Cl. A62C 3/02

(52) U.S. Cl. CPC A62C 3/0257

(57) ABSTRACT

A wildfire containment method for containing wildfires in an external environment is disclosed. The method includes providing wildfire containment barrier apparatus (10). The apparatus (10) comprises a plurality of elongate, hollow barrier members (12). Each barrier member (12) defines an interior (18), an inlet arrangement (54), through which, in use, air can enter the interior (18) and an outlet arrangement (56), through which, in use, air can exit from the interior (18). The apparatus (10) is arranged so that each barrier member (12) abuts at least one adjacent barrier member (12). In use, the barrier members (10) are installed vertically in contact with the ground.

### BACKGROUND OF THE INVENTION

### 1. Field of the Invention

The present invention relates to wildfire containment methods, particularly, but not exclusively, wildfire containment methods for containing wildfires in an external environment.

### 2. The Prior Art

Wildfires are a feature of hot, dry seasons in many countries. In hot, dry seasons, relatively small ignition events can result in wildfires which spread quickly in unconfined environments where continuous tracts of dry vegetation provide fuel. Population increase and the spread of urban settlement into wildfire prone areas means that such wildfires pose an increasing threat to human life and habitation. Typically, defences against wildfires include cleared areas to form fire breaks. Conventionally, fire barrier apparatus can be erected to slow or prevent the spread of fire and may be comprised of relatively low flammability or heat resistant materials such as steel, concrete, masonry, ceramic etc. However, such fire barrier apparatus is relatively expensive, can be heavy and bulky to transport, slow and difficult to install and only partially effective in many cases.

In this specification, the term “external environment” is used to denote a location outside of a building or outside of an enclosed space such as that defined by a vessel or tank. In this specification, the term “wildfire” is used to denote an unconfined fire in an external environment.

### SUMMARY OF THE INVENTION

According to a first aspect of the present invention, there is provided a wildfire containment method for containing wildfires in an external environment, the method including providing wildfire containment barrier apparatus, the apparatus comprising a plurality of elongate, hollow barrier members, each barrier member defining an interior, an inlet arrangement, through which, in use, air can enter the interior and an outlet arrangement, through which, in use, air can exit from the interior, the apparatus being arranged so that each barrier member abuts at least one adjacent barrier member.

In this specification, the word “abuts” has the ordinary English meaning of “locates against and is in contact with”.

Each barrier member may extend along a longitudinal axis.

Each barrier member may include a metal wall.

Each wall may define the interior of the respective barrier member.

The wall of each barrier member may define an array of through holes with at least some of the holes of the array forming the inlet arrangement.

The method may include the step of installing the barrier members with the longitudinal axis of each barrier member extending generally upwardly.

Each barrier member may include an upper end and a lower end.

In the installed condition, the apparatus may be in contact with a ground surface of the external environment.

The inlet arrangement may be located at or towards the lower end.

The outlet arrangement may be located at or towards the upper end.

Possibly, in use, the wildfire containment barrier apparatus is located in the path of a wildfire.

Possibly, the inlet arrangement is located at or towards a lower end in use of the barrier members. Possibly, the outlet arrangement is located at or towards an upper end in use of the barrier members.

Possibly, in use, the inlet arrangement permits air to enter the interior from a hot side of the apparatus, i.e. the side on which a fire is located.

Possibly, in use, the inlet arrangement permits air to enter the interior from both the hot side and a cold side, i.e. the side opposite to that on which the fire is located.

Possibly, each barrier member includes a wall, which includes an external surface. Possibly, each wall defines the interior of the respective barrier member. Possibly, the wall of each barrier member defines a plurality of through holes and may define an array of through holes. Possibly, the array extends substantially over a greater part of the wall surface.

Possibly, at least some of the holes of the array comprise the inlet arrangement.

Possibly, some of the holes of the array comprise the outlet arrangement.

Possibly, each barrier member extends along a longitudinal axis, which, in an installed condition, may extend generally upwardly.

Possibly, the barrier members are arranged in a one or more rows, and may be arranged substantially in a line.

Possibly, the barrier members are arranged in a plurality of rows. Possibly, the barrier members of one row locate partially into interstitial spaces defined by the barrier members of an adjacent row. Possibly, the barrier members of one row abut the barrier members of an adjacent row.

Possibly, each barrier member defines an end opening at an in use upper end. Possibly, the end opening comprises the outlet arrangement.

Possibly, each barrier member is in the form of a cylindrical hollow tube.

Possibly, in the uninstalled condition, each barrier member is open at both ends.

Possibly, in the installed condition, each barrier member is closed at its in use lower end, possibly by the ground.

Possibly, each barrier member wall is predominantly formed of a single layer of material.

Possibly, each barrier member wall is seamless, and may be formed as a tube.

Possibly, each barrier member comprises a sheet of material having two side edges or two side edge portions, which may be formed so that the two side edges butt against each other or the two edge portions overlap each other. Each barrier member may include one or more edge fixings which may fix the side edges or the side edge portions together.

In the installed condition, each barrier member may be free-standing, possibly with the respective lower end located in the ground.

Possibly, the apparatus includes a plurality of support members which, in the installed condition, may support the barrier members and which, in the installed condition, may engage the ground surface to anchor the apparatus to the ground surface.

Possibly, in the installed condition, an upper part of each support member is located in the interior of a respective one of the barrier members.

Possibly, the apparatus includes one or more assembly fixings. Each assembly fixing may fix one barrier member to the adjacent abutting barrier member.

The or some of the fixings may locate through the array holes.

Possibly, each barrier member is substantially circular or polygonal in cross section shape and has a maximum cross section dimension, which may be a diameter or a diagonal and may be an internal dimension or an external dimension. Desirably, each barrier member is substantially circular in cross section shape.

Possibly, the barrier members are of similar maximum cross section dimension.

Possibly, the maximum cross-section dimension is no more than 100 mm and may be no more than 70 mm.

Possibly, each array hole is substantially circular or polygonal in shape and has a maximum opening dimension, which may be a diameter or a diagonal. Possibly, all of the holes of the array are of similar maximum opening dimension.

Possibly, the maximum opening dimension of the holes of the array is no more than 40 mm and may be no more than 35 mm.

Possibly, for each barrier member, the array of holes provides a total open area, which is the sum of the areas of all of the array holes. Possibly, for each barrier member, the total open area is a proportion of the total area of the wall surface. Possibly, the proportion is at least 10%. Possibly, the proportion is no more than 95%.

Possibly, the barrier members are arranged in one or more rows when the open area proportion of each barrier member is approximately 65% and lower, and may be arranged in two or more rows when the open area proportion is greater than 65% and less than 95%.

Possibly, each barrier member is formed of a metal material and may be formed of a steel, which may be aluminium, stainless steel or galvanised mild steel. Possibly, the metal material is unpainted.

Possibly, each barrier member is formed of a meshed or perforated material. Possibly, the meshed or perforated material comprises a plurality of wire members, which may be welded, fastened, knitted or woven together in criss-cross fashion.

Possibly, the meshed or perforated material is formed from a sheet of material, which may be perforated, possibly by drilling, pressing, stamping or die cutting.

Possibly, the wall of each barrier member includes surface areas over which the array extends, and one or more solid areas, over which the array does not extend.

Possibly, the solid area(s) is located at or towards the in use upper end of the barrier member.

Possibly, the apparatus comprises a barrier module. Possibly, each module comprises a plurality of the barrier members and a frame. Possibly, the barrier members are located in the frame for storage, transportation and installation.

According to a second aspect of the present invention, there is provided a wildfire containment barrier apparatus for containing wildfires in an external environment, the apparatus comprising a plurality of elongate, hollow barrier members, each barrier member comprising:

an interior;

an inlet arrangement, through which air can enter the interior;

an outlet arrangement, through which air can exit from the interior, each barrier member abutting at least one adjacent barrier member;

each barrier member extending along a longitudinal axis,

each barrier member includes a metal wall,

each wall defines the interior of the respective barrier member;

the wall of each barrier member defines an array of through holes with at least some of the holes of the array forming the inlet arrangement;

the longitudinal axis of each barrier member extends generally upwardly, each barrier member including an upper end and a lower end,

the inlet arrangement is located at or towards the lower end and the outlet arrangement is located at or towards the upper end.

Possibly, the apparatus includes any of the features described in any of the preceding statements or following description. Possibly, the method includes any of the steps described in any of the preceding statements or following description.

### BRIEF DESCRIPTIONS OF THE DRAWINGS

Embodiments of the present invention will now be described, by way of example only, and with reference to the accompanying drawings, in which:

FIG. 1 is a perspective view of a first wildfire containment barrier apparatus comprising two rows of barrier members;

FIG. 2 is a plan view from above of the apparatus of FIG. 1;

FIG. 3 is a front view of the apparatus of FIGS. 1 and 2;

FIG. 4 is a relatively enlarged detail view of part of the first wildfire containment barrier apparatus as indicated in FIG. 3;

FIG. 5 is a perspective view of a second wildfire containment barrier apparatus comprising a single row of barrier members;

FIG. 6 is a plan view from above of the apparatus of FIG. 5;

FIG. 7 is a front view of the apparatus of FIGS. 5 and 6;

FIG. 8 is a perspective view of a third barrier apparatus comprising a single row of barrier members;

FIG. 9 is a relatively enlarged detail view of part of the third wildfire containment barrier apparatus as indicated in FIG. 8;

FIG. 10 is a side cross-sectional schematic view of the first wildfire containment barrier apparatus in an in-use condition;

FIG. 11 is a side cross-sectional schematic view of the second wildfire containment barrier apparatus in an in-use condition;

FIG. 12 is a perspective view of three barrier members with different assembly fixings;

FIG. 13 is a side view of a barrier member in an installed condition;

FIG. 14 is a cross-sectional view of a barrier member in an installed condition;

FIGS. 15A to 15D are part perspective views of barrier members formed by different forming methods.

FIG. 16 is a perspective view of four barrier members with different assembly fixings.

FIG. 17 is a perspective view of a fourth wildfire containment barrier apparatus.

### DETAILED DESCRIPTION OF THE PREFERRED EMBODIMENTS

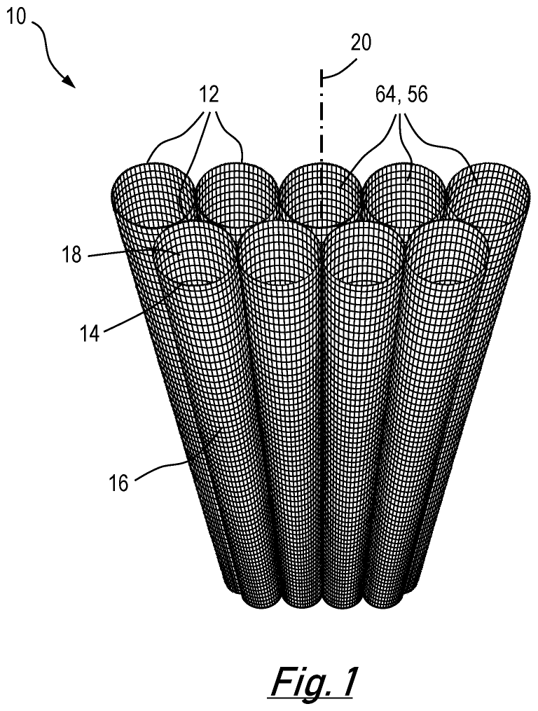

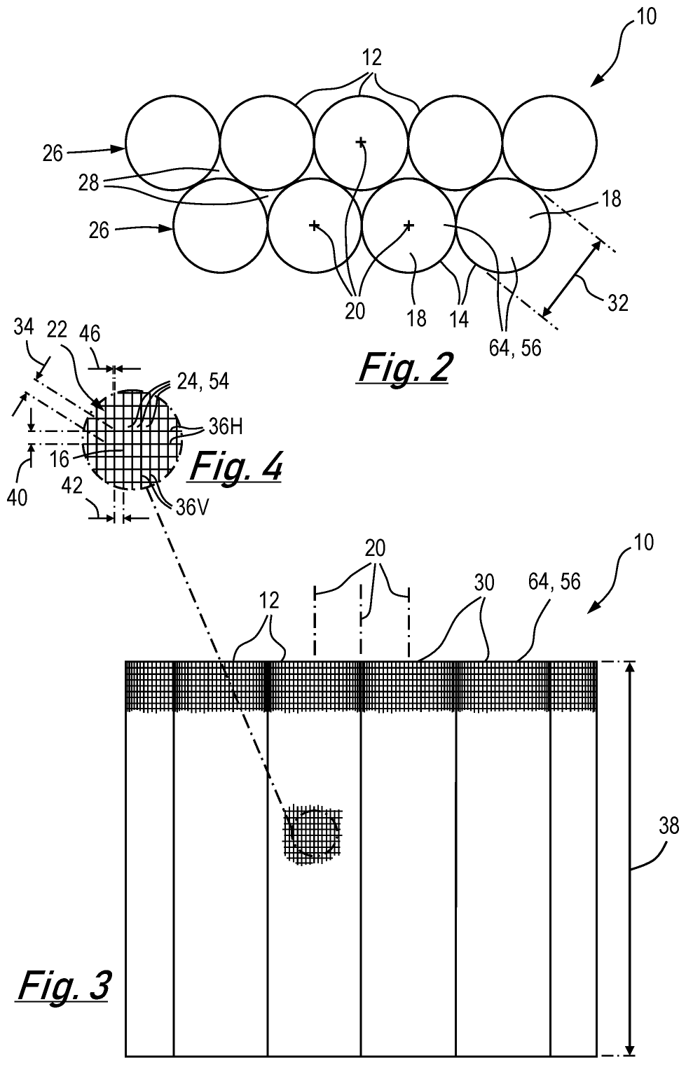

FIGS. 1 to 4 and 10 show a wildfire containment barrier apparatus 10. The apparatus 10 comprises a plurality of elongate, hollow barrier members 12. Each barrier member 12 defines an interior 18, an inlet arrangement 54, through which, in use, air can enter the interior 18 and an outlet arrangement 56, through which, in use, air can exit from the interior 18. The apparatus 10 is arranged so that each barrier member 12 abuts at least one adjacent barrier member 12.

Each barrier member 12 includes a wall 14 which includes an external surface 16. Each wall 14 defines the interior 18 of the respective barrier member 12. Each barrier member 12 extends along a longitudinal axis 20, which, in an installed condition, extends generally upwardly.

The wall 14 of each barrier member 12 defines an array 22 of through holes 24, the array 22 extending substantially over a greater part of the wall surface 16. In this example, the holes 24 comprise the inlet arrangement 54.

In the example shown in FIGS. 1 to 4 and 10, the barrier members 12 are arranged in two rows 26, each row 26 being a line of adjacent, abutting barrier members 12. The barrier members 12 of one row 26 locate partially into interstitial spaces 28 defined between the barrier members 12 of an adjacent row 26, so that each of the barrier members 12 of one row 26 abut two barrier members 12 of the adjacent row 26 (excepting the endmost barrier members 12), and two adjacent barrier members 12 of the same one row 26 (excepting, again, the endmost barrier members 12).

Each barrier member 12 defines an end opening 64 at an in use upper end 30. In this example, the end opening 64 comprises the outlet arrangement 56.

In an uninstalled condition, each barrier member 12 is open at both ends. Thus, in this example, each barrier member 12 is in the form of a cylindrical hollow tube which, in the uninstalled condition, is open at both ends.

In the example shown in FIGS. 1 to 4 and 10, each barrier member 12 is substantially circular in cross-sectional shape and has a maximum cross section dimension 32, which is an external diameter.

The barrier members 12 of the apparatus 10 are of similar cross section dimension 32.

The maximum cross-section dimension 32 could be no more than 100 mm and desirably is no more than 70 mm.

In the example shown in FIGS. 1 to 4 and 10, each array hole 24 is substantially rectangular in shape, having a height 40 and a width 42, and having a maximum opening dimension 34, which is a diagonal. All of the holes 24 of the array 22 are of similar maximum opening dimension 34.

The maximum opening dimension 34 could be no more than 40 mm and desirably is no more than 35 mm.

For each barrier member 12, the array 22 of holes 24 provides a total open area, which is the sum of all the areas of all of the array holes 24 and is a proportion of the total area of the wall surface 16. The proportion could be at least 10%. The proportion could be no more than 95%.

Each barrier member 12 is formed of an unpainted metal material and could be formed of a steel, which could be stainless steel or galvanised mild steel. In other examples, barrier members 12 could be formed of aluminium.

As shown in FIGS. 3 and 4, each barrier member 12 could be formed of a meshed or perforated material, which could comprise a plurality of wire members 36, comprising in-use vertical wire members 36V and in use horizontal wire members 36H, which are welded, fastened, knitted or woven together in criss-cross fashion.

Each barrier member wall 14 is predominantly formed of a single layer of material (rather than for example, a coil of material which would be inefficient by increasing material usage and hence cost; impeding ventilation and therefore efficiency of operation; and increasing bulk and therefore speed and ease of use.

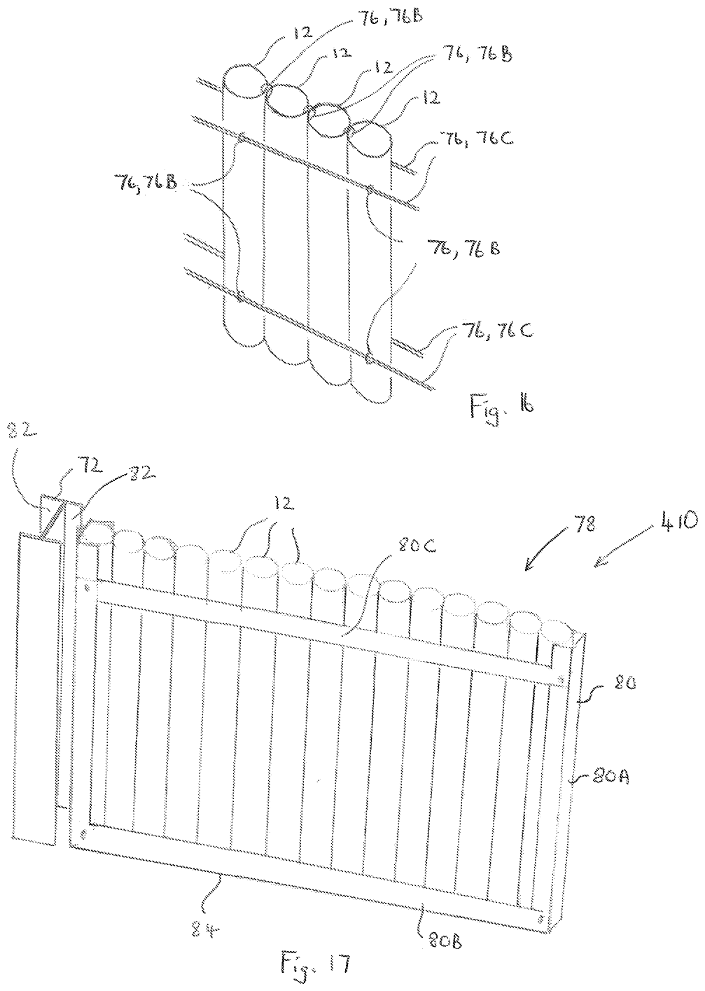

Referring to FIG. 15A, each barrier member wall 14 could be seamless, and could be formed continuously as a tube, for example by weaving or knitting wire.

Referring to FIGS. 15B to 15D, each barrier member 12 could comprise a sheet of material having two side edges 66 or two side edge portions 68, which could be formed so that the two side edges 66 butt against each other or the two edge portions 68 overlap each other. Each barrier member 12 could include one or more edge fixings 70 which fix the side edges 66 or the side edge portions 68 together. The edge fixings 70 could comprise, for example, welds such as spot welds, tack welds or stitch welds, or could comprise, for example, rivets, screws, bolts, wire clips or wire ties or some other form of fire resistant fixings.

In one example, wire ties (not shown) could extend through the array holes 24 to facilitate rapid forming.

Referring to FIGS. 12 and 16, the apparatus 10 could include one or more assembly fixings 76. Each assembly fixing 76 fixes one barrier member 12 to the adjacent abutting barrier member 12.

The assembly fixings 76 could comprise, for example, welds 76A such as spot welds, tack welds or stitch welds, or could comprise, for example, rivets, screws, bolts, wire clips or wire ties 76B, rods 76C or some other form of fire resistant fixings.

Some or all of the assembly fixings 76 could locate through the array holes 24, e.g. the rods 76C in FIG. 12.

Advantageously, use of the array holes 24 for locating the fixings 76 therethrough facilitates rapid forming, assembly and erection.

The barrier members 12 have a height 38. In general, the higher the barrier members 12, the better, to avoid carry over of fire over the top of the barrier members 12. In practice, the height 38 is limited by practical considerations, and, for example, could be in the range 700 mm to 3000 mm.

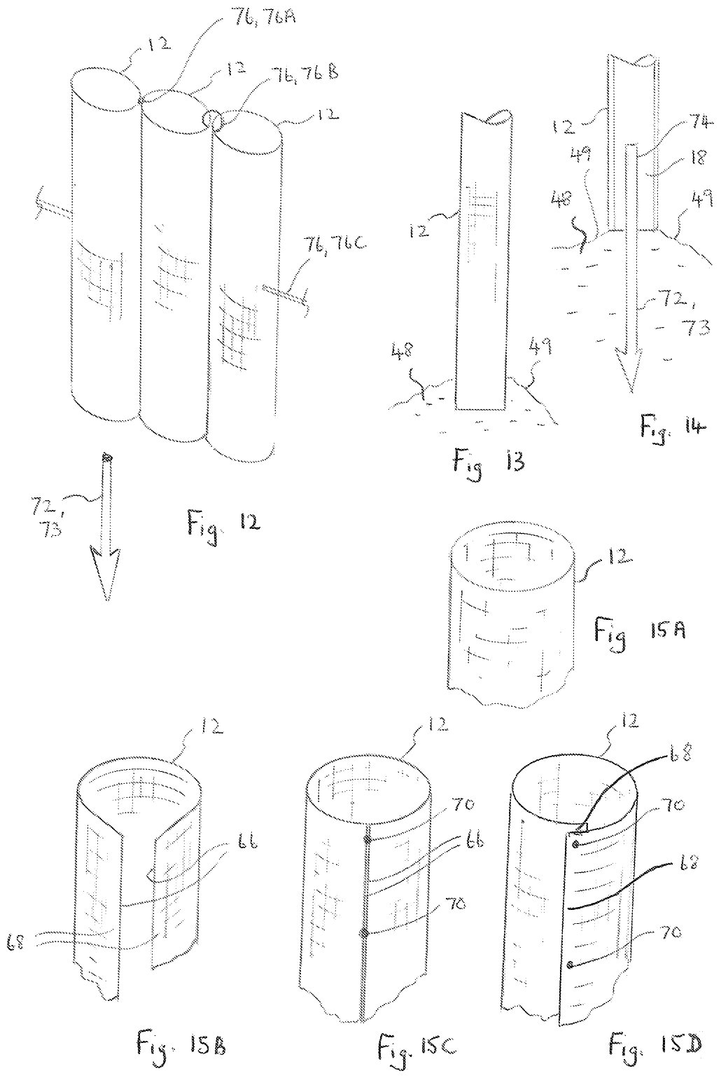

In use, in one example, as shown in FIGS. 10, 13 and 14, the barrier members 12 are installed so that one end is closed by the ground 48, being either in the ground 48 or on the ground surface 49. If the ground conditions permit, the barrier members 12 could be partially buried in the ground, so that the ground 48 provides support to keep the longitudinal axes 20 substantially vertical, as shown in FIG. 13. Otherwise, or in addition, referring to FIGS. 12 and 14, the apparatus 10 could include a plurality of support members 72 which, in the installed condition, could support the barrier members 12 and which, in the installed condition, engage the ground 48 to anchor the apparatus 10 to the ground 48.

In one example, the support members 72 could comprise ground anchors 73 which are partially buried in the ground with an upper part 74 projecting upwardly above the ground 48, which upper part 74 is received in the interior 18 of a respective one of the barrier members 12. This arrangement facilitates rapid erection.

The functioning of the wildfire containment barrier apparatus 10 in use is discussed further below.

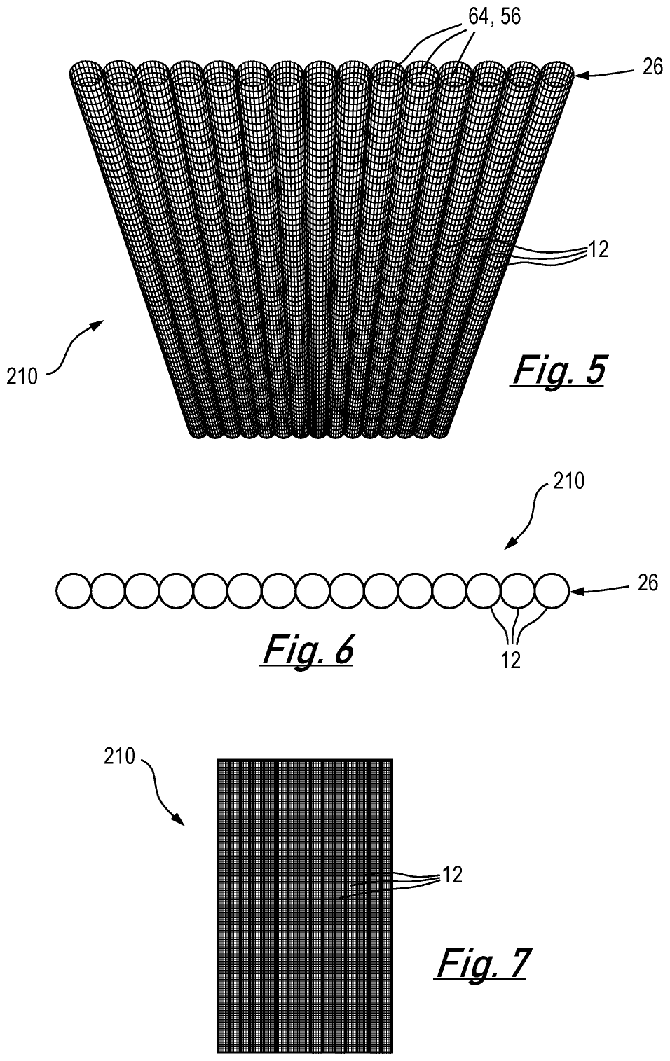

FIGS. 5 to 9, 11 to 14 and 17 show other embodiments of the invention, many features of which are similar to those already described in relation to the embodiment of FIGS. 1 to 4 and 10. Therefore, for the sake of brevity, the following embodiments will only be described in so far as they differ from the embodiment already described. Where features are the same or similar, the same reference numerals have been used and the features will not be described again.

FIGS. 5 to 7 and 11 to 14 show a second wildfire containment barrier apparatus 210. In this example, the barrier members 12 are arranged substantially in a line in a single row 26. In this example, the barrier members 12 are formed of substantially the same material as the first wildfire containment barrier apparatus 10 described above.

In the installed condition as shown in FIG. 13, each barrier member 12 could be free-standing, with the respective lower end located in the ground 48.

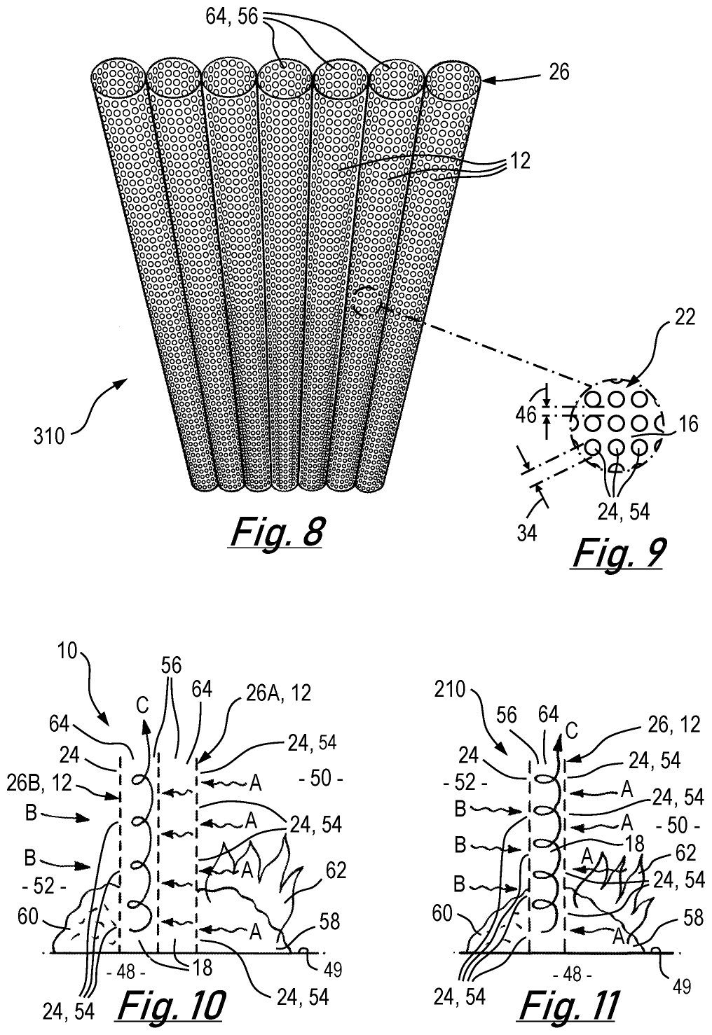

FIGS. 8 and 9 show a third wildfire containment barrier apparatus 310, in which the barrier members 12 are again arranged substantially in a line in a single row 26. In this example, each barrier member 12 is formed of a perforated material, for example, from a sheet of material which has been perforated, for example, by drilling, pressing, stamping or die cutting. The array holes 24 in this example are circular.

FIG. 17 shows a fourth wildfire containment barrier apparatus 410 which comprises a barrier module 78. The module 78 comprises a plurality of the barrier members 12 and a frame 80, 80A, 80B, 80C. The barrier members 12 are located in the frame 80 for storage, transportation and installation. The modules 78 permit rapid deployment. The modules 78 could be supported by support members 72 which in this embodiment comprise fence posts, which could define channels 82 in which ends of the module 78 are receivable.

In the example shown, the frame 80 accommodates a single row of barrier members 12, but in other examples, the frame 80 could accommodate a plurality of rows.

The barrier members 12 could be removably located into the frames 80 without fixings to enable the modules 78 to be constructed in situ, or could be fixed into the frames 80.

The module 78 has a base 84 which, in the installed condition, locates on the ground 48.

Advantageously, the barrier apparatus 10, 210, 310, 410 can be erected rapidly on a temporary basis as required in the event of a wildfire and can be moved quickly into the path of the wildfire as the fire changes direction. The barrier members 12 are easy to store and install. The method of installation, fixings and number of rows can be selected in accordance with local conditions such as ground conditions and fire severity. After the fire threat has receded, the barrier members 12 can be recovered and stored to prevent damage by livestock.

The applicant has tested a number of examples of fire barrier assemblies in experiments to identify the design parameters which determine the effectiveness of use as a fire barrier. The experiments undertaken and the results are summarised in Table 1 and observations given below. FIGS. 10 and 11 show in general the arrangement of single row and double row fire barrier assemblies in the experiments.

Table 1 includes a dimension “Spacing between array holes 46” shown in FIGS. 4 and 9, which equates to the thickness of the material between the holes 24, e.g. the wire gauge. In each experiment, a first amount 58 of combustible material was set on fire against one side (designated the “hot side 50”) of the fire barrier being tested, with a second amount 60 of combustible material located on the other side (designated the “cold side 52”), and the ability of the fire barrier to prevent the spread of the fire to the second amount 60 of combustible material was observed.

### Experiment 1

In this experiment, the barrier members 12 were provided in the form of the first wildfire containment barrier apparatus 10 shown in FIG. 10, comprising two rows 26A, 26B of cylindrical open ended tubes of a meshed material. Hot air as shown by arrows A and naked flames 62 managed to pass through the first row 26A but did not progress past the second row 26B. Observed occasional vertical spiralling of flame in second row 26B of barrier members 12. No ignition of combustible material 60 resting directly against the rear of the second row 26A.

### Experiment 2

In this experiment, the barrier members 12 were provided in the form of the second wildfire containment barrier apparatus 210, comprising one row 26 of cylindrical open ended tubes of a meshed material. Fire passed through the barrier members 12 to ignite the second amount 60 of combustible material behind the wildfire containment barrier apparatus 210.

### Experiment 3

In this experiment, the barrier members 12 were provided in the form of the second wildfire containment barrier apparatus 210, comprising one row 26 of cylindrical open ended tubes of a meshed material. There was no passage of fire through the wildfire containment barrier apparatus 210 and the second amount 60 of combustible material remained unlit.

TABLE 1
Summary of Experimental Results

| | | | | Maximum | | | | | | | | |
|---|---|---|---|---|---|---|---|---|---|---|---|---|
| | | | | cross | | | | Array | | Open | | |
| | | | | section | | | | hole | Spacing | area % | | |
| | | | Cross | dimension | | Array | Array | max | between | of array | No of | |
| | | Height 38 | section | 32 (mm) of | | hole | hole | opening | array | holes | rows 26 | |
| | Material of | of barrier | shape of | barrier | Array | height | width | dimension | holes | 24/wall | of barrier | |
| Exper- | barrier | member 12 | barrier | member | hole | 40 | 42 | 34 | 46 | surface | members | Effec- |
| iment | member 12 | (mm) | member 12 | interior 18 | shape | (mm) | (mm) | (mm) | (mm) | 16 | 12 | tive? |
| 1 | Galvanised | 620 | Circular | 50 | Square | 25 | 25 | 35.4 | 1.0 | 92.5 | 2 | Yes |
| | steel | | | | | | | | | | | |
| 2 | Galvanised | 600 | Circular | 300 | Square | 6 | 6 | 8.5 | 1.0 | 73.5 | 1 | No |
| | steel | | | | | | | | | | | |
| 3 | Stainless | 720 | Circular | 22 | Square | 3 | 3 | 4.2 | 0.80 | 62.3 | 1 | Yes |
| | steel | | | | | | | | | | | |
| 4 | Galvanised | 900 | Circular | 55 | Square | 13 | 13 | 18.4 | 0.9 | 87.5 | 1 | No |
| | steel | | | | | | | | | | | |
| 5 | Galvanised | 900 | Circular | 55 | Square | 13 | 13 | 18.4 | 0.9 | 87.5 | 2 | Yes |
| | steel | | | | | | | | | | | |
| 6 | Galvanised | 900 | Square | 70.7 | Square | 13 | 13 | 18.4 | 0.9 | 87.5 | 2 | No |
| | steel | | (50 × 50) | | | | | | | | | |
| 7 | Galvanised | 900 | Square | 70.7 | Square | 13 | 13 | 18.4 | 0.9 | 87.5 | 1 | No |
| | steel | | (50 × 50) | | | | | | | | | |
| 8 | Galvanised | 900 | Circular | 140 | Square | 13 | 13 | 18.4 | 0.9 | 87.5 | 1 | No |
| | steel | | | | | | | | | | | |

### Experiment 4

In this experiment, the barrier members 12 were provided in the form of the second wildfire containment barrier apparatus 210, comprising one row 26 of cylindrical open ended tubes of a meshed material. Ignition of the second amount 60 of combustible material occurred.

### Experiment 5

In this experiment, the barrier members 12 were provided in the form of the second wildfire containment barrier apparatus 210, comprising one row 26 of cylindrical open ended tubes of a meshed material. No ignition of the second amount 60 of combustible material occurred.

### Experiment 6

In this experiment, a fourth wildfire containment barrier apparatus (not shown) comprised two rows of barrier members 12 in the form of square section open ended tubes of a meshed material. Ignition of the second amount 60 of combustible material occurred.

### Experiment 7

In this experiment, a fifth wildfire containment barrier apparatus (not shown) comprised one row of barrier members 12 in the form of square section open ended tubes of a meshed material. Ignition of the second amount 60 of combustible material occurred.

### Experiment 8

In this experiment, the barrier members 12 were provided in the form of the second wildfire containment barrier apparatus 210, comprising one row 26 of cylindrical open ended tubes of a meshed material. Fire progressed easily though the barrier members to ignite the second amount 60 of combustible material.

In broad terms, these experiments appear to show that:
a. increasing the number of rows increases the effectiveness for a given array hole size and open area proportion;
b. circular cross section barrier members 12 are more effective than square section barrier members 12;
c. as the maximum cross section dimension 32 increases above 55 mm, effectiveness decreases;
d. a smaller array hole maximum opening dimension and open area proportion is more effective;
e. a single row of barrier members might be sufficient where the open area proportion is approximately 65% and lower;
f. at least two rows of columns will be required for an open area proportion greater than 65% and less than 95%.

Thus, according to these preliminary results, the barrier members could be arranged in one or more rows when the open area proportion of each barrier member is approximately 65% and lower, and could be arranged in two or more rows when the open area proportion is greater than 65% and less than 95%. However, rather than these results being limiting to the scope of the invention, they are presented to demonstrate that, in principle, the barrier members of the invention can be used in wildfire containment.

The applicant initially took inspiration from the use of wire gauze to contain flame in mining safety lamps. Clearly, however, wire gauze is impractical for use in large scale flame barriers. The above results show that the principle of flame containment by a meshed or perforated metal material appears to operate at a larger scale. However, the applicant has surprisingly found from observation that one or more other effects in addition to the screening effect of mesh may be involved, namely a chimney effect, a vortex effect, a thermal radiation reduction effect and a heat sink effect.

The applicant believes that the cylindrical tube-like shape of the barrier members is important and has observed the formation of upwardly moving vortices of hot smoky air within the interiors 18 during the successful experiments. Square section barrier members 12 may be less effective because they are less conducive to vortex formation. Similarly, large diameter cross section barrier members 12 may be less effective because they do not induce vortex formation.

The applicant believes that an open area of 92.5% is getting close to the limit of effectiveness for the invention and that practically a figure of 95% provides an upper limit for the open area proportion. As the open area proportion increases, there is less resistance to through air flow and less chance for vortices to form.

The applicant believes that as the flames 62 approach the wildfire containment barrier apparatus 10, 210, the flames 62 will cause movement of hot air (arrow A) from the hot side 50 and cooler air (arrow B) from the cold side 52 towards the barrier members and into the interior 18. As the hot and cold air from opposite sides of the barrier member meet, a vortex forms which moves upwardly as shown by arrow C. A chimney effect is then formed in which the upwardly moving air and the vortex formation suck in more air and eject it upwards, so that each of the barrier members effectively becomes a small chimney. The mixing of the hot air and the cooler air serves to cool the barrier members. Furthermore, the heat from the hot side will in general be dissipated throughout the metal structure of the apparatus and therefore reduce the risk of the fire progressing through the barrier members or reaching a temperature above auto-ignition of the combustible material.

In addition, the applicant believes that the two sides of a column has the effect of reducing the overall open area proportion as against thermal radiation, which travels in a straight line. Thermal radiation from a fire passing through the fire facing mesh side, must also pass the rear mesh side of the column if it is to heat combustible material on the cold side.

Thus, the wildfire containment barrier apparatus prevents the passage of both heat and flame across the apparatus.

The results above appear to show that with the larger mesh sizes and open area proportions an additional row of barrier members is required, with the front row 26A acting to reduce air velocity to enable the second row of barrier members to generate the vortices, as shown in FIG. 10.

Another way of describing the above is that the first row of barrier members acts as a diffuser to reduce the velocity and increase the static pressure of the air flow. In the case when the air velocity is sufficiently low, then vortices can form in the first row. However, as the airflow increases to the point that vortices cannot form in the first row, the first row acts as a diffuser to slow the air velocity entering the second row of barrier members where vortices can then form.

Due to the effects of turbulence, as a general rule the greater the open area the less resistance there will be to the velocity of the air passing through the mesh. A mesh with a much lower open area will increase resistance to the air flow (increasing pressure on the mesh) and reduce the velocity of the air passing through.

Various other modifications could be made without departing from the scope of the invention. The wildfire containment barrier apparatus and the components thereof could be of any suitable size and shape, and could be formed of any suitable material (within the scope of the specific definitions herein).

For example, the barrier members could be different in cross section shape, e.g. polygonal. The maximum cross section dimension 32 could be a diameter or a diagonal, and could be an internal dimension or an external dimension.

Each array hole could be polygonal in shape and the maximum opening dimension 34 could be a diameter or a diagonal.

In one example, some of the holes of the array could comprise the outlet arrangement.

In one example, the wall of each barrier member could include surface areas over which the array extends, and one or more solid areas (not shown), over which the array does not extend. The solid area(s) is located at or towards the in use upper end of the barrier member.

Adjacent barrier members could be fixed together and/or to a support by any convenient means, such as, for example, welding, using fasteners such as bolts, screws, or rivets, or by clips.

Any of the features or steps of any of the embodiments shown or described could be combined in any suitable way, within the scope of the overall disclosure of this document.

There is thus provided fire barrier assemblies with a number of advantages over conventional arrangements. In particular, the fire barrier assemblies can be very quickly erected as required, for example, in a wildfire situation. The barrier members are of simple construction and formed of standard readily available materials.

Advantageously, following use the barrier members can be easily uninstalled and kept for reuse, refurbishment or recycling.

What is claimed is:

1. A wildfire containment method for containing wildfires in an external environment, the method including the step of providing wildfire containment barrier apparatus, the apparatus comprising a plurality of elongate, hollow barrier members, each barrier member comprising:
an interior;
an inlet arrangement, through which air can enter the interior;
an outlet arrangement, through which air can exit from the interior,
the method including arranging the apparatus, so that, in an installed condition,
each barrier member abuts at least one adjacent barrier member;
each barrier member extends along a longitudinal axis,
each barrier member includes a metal wall,
each wall defines the interior of the respective barrier member;
the wall of each barrier member defines an array of through holes with at least some of the holes of the array forming the inlet arrangement;
wherein, the method includes the step of installing the barrier members with the longitudinal axis of each barrier member extending generally upwardly, with each barrier member including an upper end and a lower end,
wherein, in the installed condition, the apparatus in contact with a ground surface of the external environment;
wherein the inlet arrangement is located at or towards the lower end and the outlet arrangement is located at or towards the upper end.

2. The method according to claim 1, in which, in use, the inlet arrangement permits air to enter the interior from a hot side of the apparatus where a fire is located or from both the hot side where a fire is located and a cold side.

3. The method according to claim 1, in which some of the holes of the array comprise the outlet arrangement, and/or each barrier member defines an end opening at the upper end which comprises the outlet arrangement.

4. The method according to claim 1, in which each barrier member is in the form of a cylindrical hollow tube.

5. The method according to claim 1, in which, in an uninstalled condition, each barrier member is open at both ends.

6. The method according to claim 1, in which, in the installed condition, each barrier member is closed at its lower end by the ground.

7. The method according to claim 1, in which each barrier member wall is predominantly formed of a single layer of material.

8. The method according to claim 1, in which each barrier member wall is seamless, and is formed as a tube.

9. The method according to claim 1, in which each barrier member comprises a sheet of material having two side edges or two side edge portions, which is formed so that the two side edges butt against each other or the two edge portions overlap each other, each barrier member including one or more edge fixings which fix the side edges or the side edge portions together.

10. The method according to claim 1, in which, in the installed condition, each barrier member is free-standing, with the respective lower end located in the ground.

11. The method according to claim 1, in which the apparatus includes a plurality of support members which, in the installed condition, support the barrier members and which, in the installed condition, engage the ground surface to anchor the apparatus to the ground surface.

12. The method according to claim 11, in which, in the installed condition, an upper part of each support member is located in the interior of a respective one of the barrier members.

13. The method according to claim 1, in which the apparatus includes one or more assembly fixings, wherein each assembly fixing fixes one barrier member to the adjacent abutting barrier member.

14. The method according to claim 1, in which the or some of the fixings locate through the array holes.

15. The method according to claim 1, wherein the barrier members are arranged in one or more rows.

16. The method according to claim 1, wherein the barrier members are arranged in a plurality of rows, with the barrier members of one row abutting the barrier members of an adjacent row and the barrier members of the one row are partially located in interstitial spaces defined by the barrier members of the adjacent row.

17. The method according to claim 1, in which each barrier member is substantially circular or polygonal in cross section shape and has a maximum cross section dimension, which is a diameter or a diagonal; the maximum cross-section dimension is an external dimension, and is no more 70 mm; for each barrier member, the array of holes provides a total open area, which is the sum of the areas of all of the array holes, and, in which, for each barrier member, the proportion of the total open area to the total area of the wall surface is at least 10%, and is no more than 95%; wherein, in use, the barrier members are arranged in one or more rows when the open area proportion of each barrier member is approximately 65% and lower, and are arranged in two or more rows when the open area proportion is greater than 65% and less than 95%.

18. The method according to claim 1, in which the apparatus comprises a barrier module, each module comprising a plurality of the barrier members and a frame, wherein the barrier members are located in the frame for storage, transportation and installation.

19. A wildfire containment barrier apparatus for containing wildfires in an external environment, the apparatus comprising a plurality of elongate, hollow barrier members, each barrier member comprising:
an interior;
an inlet arrangement, through which air can enter the interior;
an outlet arrangement, through which air can exit from the interior,
each barrier member abutting at least one adjacent barrier member;
each barrier member extending along a longitudinal axis,
each barrier member includes a metal wall,
each wall defines the interior of the respective barrier member;
the wall of each barrier member defines an array of through holes with at least some of the holes of the array forming the inlet arrangement;
the longitudinal axis of each barrier member extends generally upwardly, each barrier member including an upper end and a lower end,
the inlet arrangement is located at or towards the lower end and the outlet arrangement is located at or towards the upper end.
